(19) United States
(12) Patent Application Publication
(10) Pub. No.: US 2015/0266450 A1
(43) Pub. Date: Sep. 24, 2015

(54) Automated Alert Light System

(71) Applicant: Tim Gilson, De Pere, WI (US)

(72) Inventor: Tim Gilson, De Pere, WI (US)

(21) Appl. No.: 14/657,028

(22) Filed: Mar. 13, 2015

Related U.S. Application Data
(60) Provisional application No. 61/955,147, filed on Mar. 18, 2014.

(51) Int. Cl. B60R 25/104; G08B 5/36; B60R 25/10

(52) U.S. Cl. CPC B60R 25/104; B60R 25/1004; G08B 5/36

(57) ABSTRACT

An automated alert light system can comprise a battery-powered light that can be activated by a movement sensor, such that the light remains active during vehicular motion, but turns off automatically when it is no longer needed, thereby conserving the battery. The battery can be recharged through physical connections with charging apparatuses, including docking-based mechanisms. The light can be deactivated based on an elapsed time since structural motion was last detected, which can be fixed or user-adjustable. The automated alert light system can also comprise a magnetic base by which it can be attached and removed, and it can further comprise solar panels to enable recharging. The system can comprise multiple, physically independent light components that can interoperate with a centralized controller, which can either be integrated or a separate, stand-alone unit. Sensors, lights, or other components can be communicationally coupled thereto with wireless communications.

### CROSS-REFERENCE TO RELATED APPLICATION

This application claims the benefit of U.S. Provisional Patent Application Ser. No. 61/955,147 filed on Mar. 18, 2014.

### BACKGROUND

Many vehicles require various forms of light-based alert systems to notify others to their presence. For example, large farm equipment often requires flashing lights to be placed on such equipment when it utilizes public roads. As another example, bicycles often have flashing lights attached to them to alert drivers to the presence of the bicyclist, especially at night or in other limited visibility situations. Unfortunately, such light-based alert systems are often inconvenient to maintain and operate properly. For example, hardwired light-based alert systems cannot be easily moved among various different equipment. As such, for large equipment, such as farm equipment, that is often rented for a limited duration, the rental company is forced to either install hardwired light-based alert systems on each equipment that they rent, or require renters to provide their own light-based alert systems, thereby adding additional cost and complexity to the renting of such equipment. As another example, battery operated light-based alert systems are often forgotten in the active position, thereby prematurely draining the battery and not being operational during a subsequent use.

### SUMMARY

In one embodiment, an automated alert light system can comprise a battery-powered light that can be activated by a movement sensor, such that the light remains active during vehicular movement, but turns off automatically when it is no longer needed, thereby conserving the battery. Such a battery can be recharged through physical connections with charging apparatuses, which can be connected to a housing comprising such a battery, including through docking-based mechanisms.

In another embodiment, an automated alert light system can comprise a battery-powered light and magnetic base by which such an automated alert light system can be easily and efficiently attached and removed from vehicles having metallic surfaces.

In yet another embodiment, an automated alert light system can comprise solar panels to enable recharging of a power source that is co-located with the automated alert light system, thereby enabling the automated alert light system to remain on a vehicle without the attendant disadvantages of being hardwired to such a vehicle.

In a further embodiment, an automated alert light system can comprise a battery-powered light that can be activated by a movement sensor and deactivated based on an elapsed time since structural motion was last detected by the movement sensor. Such elapsed time can be fixed, or it can be user adjustable, including through externally mounted adjustment mechanisms.

In a still further embodiment, an automated light alert system can comprise multiple, physically independent light components that can interoperate with a centralized controller, which can either be integrated with one of the light components, or can be a separate, stand-alone unit.

In a still further embodiment, an automated alert light system can be communicationally coupled with sensors, lights, or other components through wireless communications.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a diagram of an exemplary automated light alert device.

FIG. 2 is a diagram of alternative exemplary mounting mechanisms for an exemplary automated light alert device.

FIG. 3 is a diagram of an exemplary docking mechanism for an exemplary automated light alert device;

FIG. 4 is a diagram of an exemplary automated light alert system; and

FIG. 5 is a diagram of an exemplary automated light alert circuit.

### DETAILED DESCRIPTION

The following description relates to an automated alert light system. The automated alert light system can comprise a battery-powered light that can be activated by a movement sensor, such that the light remains active during vehicular motion, but turns off automatically when it is no longer needed, thereby conserving the battery. The battery can be recharged through physical connections with charging apparatuses, which can be connected to a housing comprising such a battery, including through docking-based mechanisms. The alert light can be deactivated, after being triggered by the movement sensor, based on an elapsed time since structural motion was last detected by the movement sensor. Such elapsed time can be fixed, or it can be user adjustable, including through externally mounted adjustment mechanisms. The automated alert light system can also comprise a magnetic base by which such an automated alert light system can be easily and efficiently attached and removed from vehicles having metallic surfaces. Alternatively, or in addition, the automated alert light system can comprise straps or brackets by which it can be attached to a vehicle. The automated alert light system can further comprise solar panels to enable recharging of a power source that is co-located with the automated alert light system, thereby enabling the automated alert light system to remain on a vehicle without the attendant disadvantages of being hardwired to such a vehicle. The automated alert light system can comprise multiple, physically independent light components that can interoperate with a centralized controller, which can either be integrated with one of the light components, or can be a separate, stand-alone unit. Additionally, the automated light alert system can be communicationally coupled with sensors, lights, or other components through wireless communications.

The techniques described herein focus on light-based alert systems, such as for vehicles. However, such descriptions are not meant to suggest a limitation of the described structures. To the contrary, the described structures are equally applicable to any environment in which the need for light to act as an alert notification is triggered by, or associated with, structural motion. Consequently, references to vehicles and flashing lights are exemplary only and are not meant to limit the mechanisms described to only those environments.

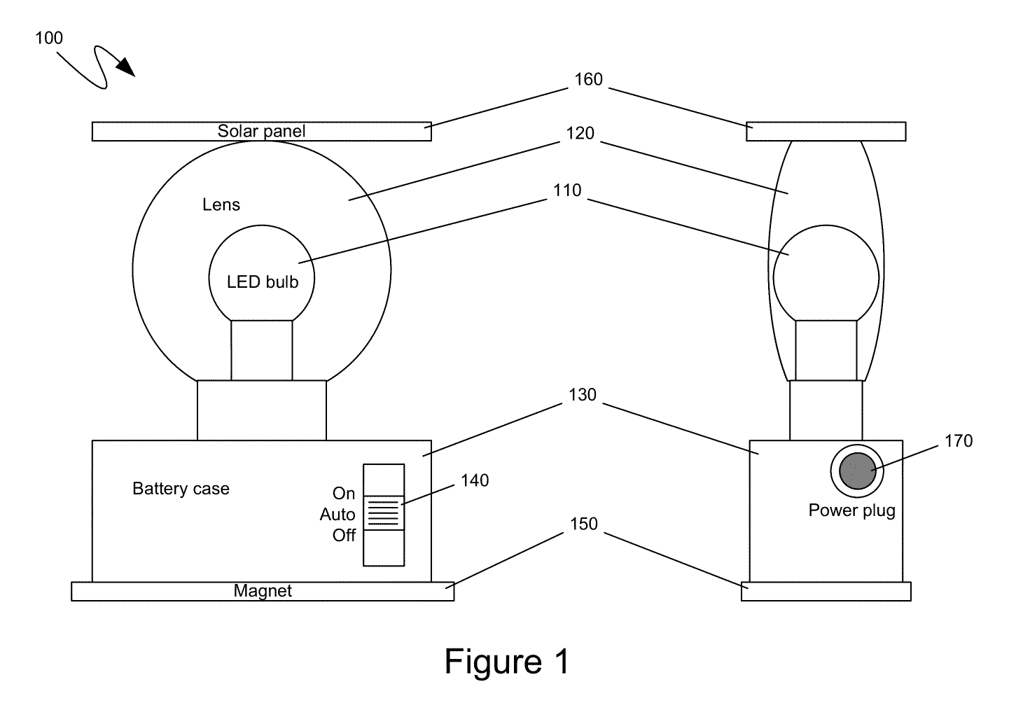

With reference to FIG. 1, an exemplary light-based alert device 100 is illustrated. In one embodiment, the exemplary light-based alert device 100 can comprise a light source, such as the exemplary Light Emitting Diode (LED) bulb 110. As will be recognized by those skilled in the art, other types of light sources, such as incandescent lightbulbs, halogen light bulbs, fluorescent lightbulbs, photoluminescent material, and other like light sources, can equally be utilized in place of the LED bulb 110. The exemplary light-based alert device 100 can further comprise a lens 120 that can provide protection to the LED bulb 110. In one embodiment, the lens 120 can be a clear lens and the light source, such as the exemplary LED bulb 110, can be colored in accordance with the relevant coloring required of the light-based alert device 100 by applicable laws or regulations relevant to the utilization of the exemplary light-based alert device 100. For example, in moving vehicle applications, the lens 120 can be clear, while the LED bulb 110 can comprise an LED that emits orange light. In an alternative embodiment, the lens 120 can provide filtering and coloring to the light emitted by the light source contained within it, such as exemplary LED bulb 110.

As illustrated in FIG. 1, the exemplary light-based alert device 100 can further comprise a battery case 130 that can house a power source for the light source, such as a battery, capacitor, flywheel, or any other electrical, mechanical or electromechanical power source. In one embodiment, the battery contained within the battery case 130 can be a rechargeable battery such as, for example, a sealed lead acid battery, a lithium battery, nickel metal hydride battery, a nickel cadmium battery, and other like rechargeable batteries.

In addition, in one embodiment, the exemplary light-based alert device 100 can further comprise a switch 140 that can dictate the transition between an active and inactive state. For example, the exemplary switch 140, shown in FIG. 1, comprises three distinct positions corresponding to an “On” position, or setting, an “Off” position, or setting, and an “Auto” position, or setting. In the “On” position, the exemplary switch 140 can cause the light source, such as exemplary LED bulb 110, to be in an active state. Such an active state can include continuous light provision, as well as intermittent light provision such as, for example, a flashing light. In the “Off” position, the exemplary switch 140 can cause a light source to be in an inactive state. In the “Auto” position, as will be described in further detail below, the exemplary switch 140 can enable the light source, such as exemplary LED bulb 110, to be activated and deactivated based upon vehicular motion, or other like movement.

The exemplary light-based alert device 100 can further comprise a power plug 170, or other like mechanism through which electrical power can be provided to the battery contained in the battery case 130 to provide for recharging of such a battery, or other like energy storage device. For example, an external AC-to-DC converter can be utilized to convert conventional AC electrical energy into DC electrical energy, which can be utilized to recharge one or more batteries in the exemplary battery case 130. Such an external AC-to-DC converter can be electrically coupled to such a battery via the power plug 170. As an alternative example, the power plug 170 can accept AC electrical power and the exemplary battery case 130 can comprise an internal AC-to-DC converter, or other like power supply that can accept AC electrical power and convert it into a form utilizable by the light-based alert device 100. In the former example, the power plug 170 can comprise a male or female coaxial power plug, or other like power plug for accepting DC electrical power. In the latter example, the power plug 170 can comprise a two- or three-prong electrical power plug, or other like power plug for accepting AC electrical power. Other types of power plugs can equally be utilized.

In one embodiment, as shown in FIG. 1, the exemplary light-based alert device 100 can comprise a solar panel 160 or other like device that can convert environmental aspects into energy that can be stored in the energy storage device contained in the battery case 130. For example, the exemplary solar panel 160 can provide sufficient electrical power to charge the battery, in the battery case 130. Such electrical power can be provided, by the exemplary solar panel 160, while the light-based alert device 100 is in an active state, an inactive state, or combinations thereof

The exemplary light-based alert device 100 can further comprise attachment mechanisms by which the exemplary light-based alert device 100 can be physically attached, such as to a vehicle or other like supporting structure. One exemplary attachment mechanism can be a magnet, such as the exemplary magnet 150 shown in FIG. 1. The exemplary magnet 150 can be sized so as to firmly secure the exemplary light-based alert device 100 to, for example, a vehicle so as to prevent the exemplary light-based alert device 100 from inadvertently detaching during vehicular motion and movement. Conversely, the exemplary magnet 150 can also be sized so as to enable the exemplary light-based alert device 100 to be detachable without specialized equipment or an excessive application of force. Such an exemplary magnet 150 can, thereby, enable the exemplary light-based alert device 100 to be conveniently attached to a vehicle, and then subsequently removed when such a vehicle is no longer in need of light-based alert devices.

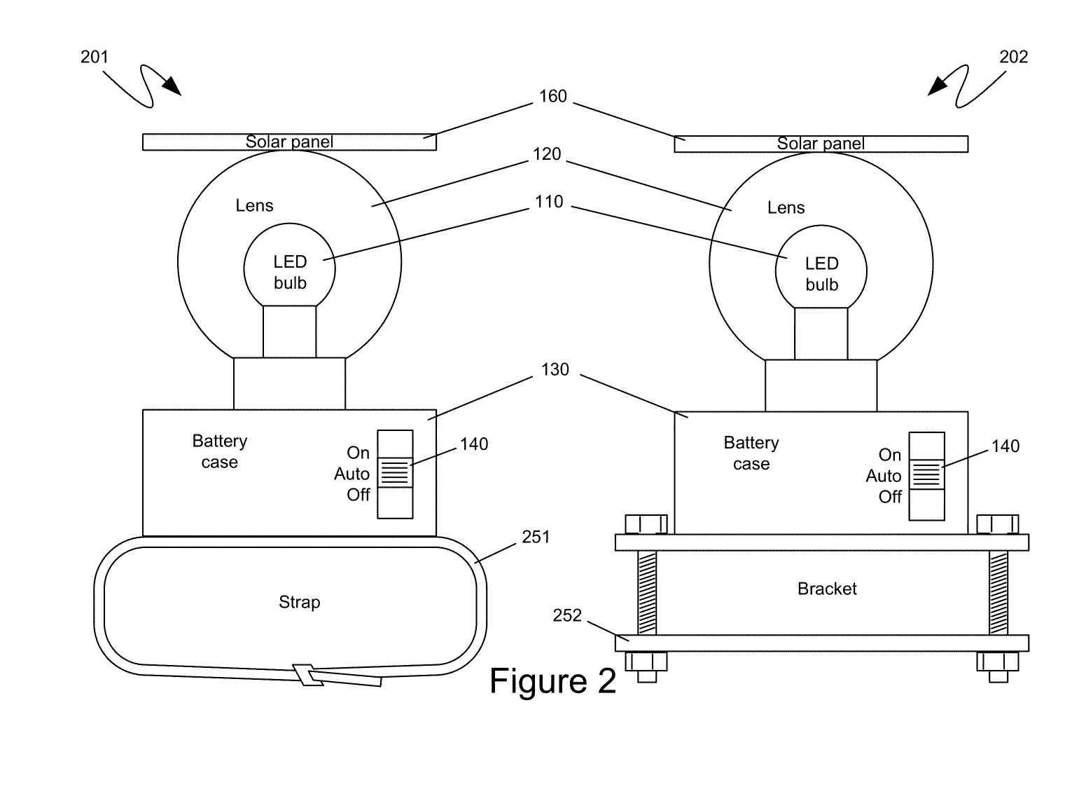

Other attachment mechanisms can, likewise, enable the exemplary light-based alert device 100 to be conveniently attached and removed from supporting structures, such as vehicles. Turning to FIG. 2, exemplary light-based alert devices 201 and 202 are illustrated, each having different attachment mechanisms. For example, exemplary light-based alert device 201 can comprise the same components as those described in detail above with reference to the exemplary light-based alert device 100 of FIG. 1, except that, instead of the magnet 150, the exemplary light-based alert device 201 can comprise a strap 251 by which the exemplary light-based alert device 201 can be strapped to a vehicle or other like supporting structure. Similarly, as another example, the exemplary light-based alert device 202 can, likewise, comprise the same components as those described in detail above with reference to the exemplary light-based alert device 100 of FIG. 1, except that, instead of the magnet 150, the exemplary light-based alert device 202 can comprise a clamp or bracket 252 by which the exemplary light-based alert device 202 can be clamped or bracketed to a vehicle or other like supporting structure.

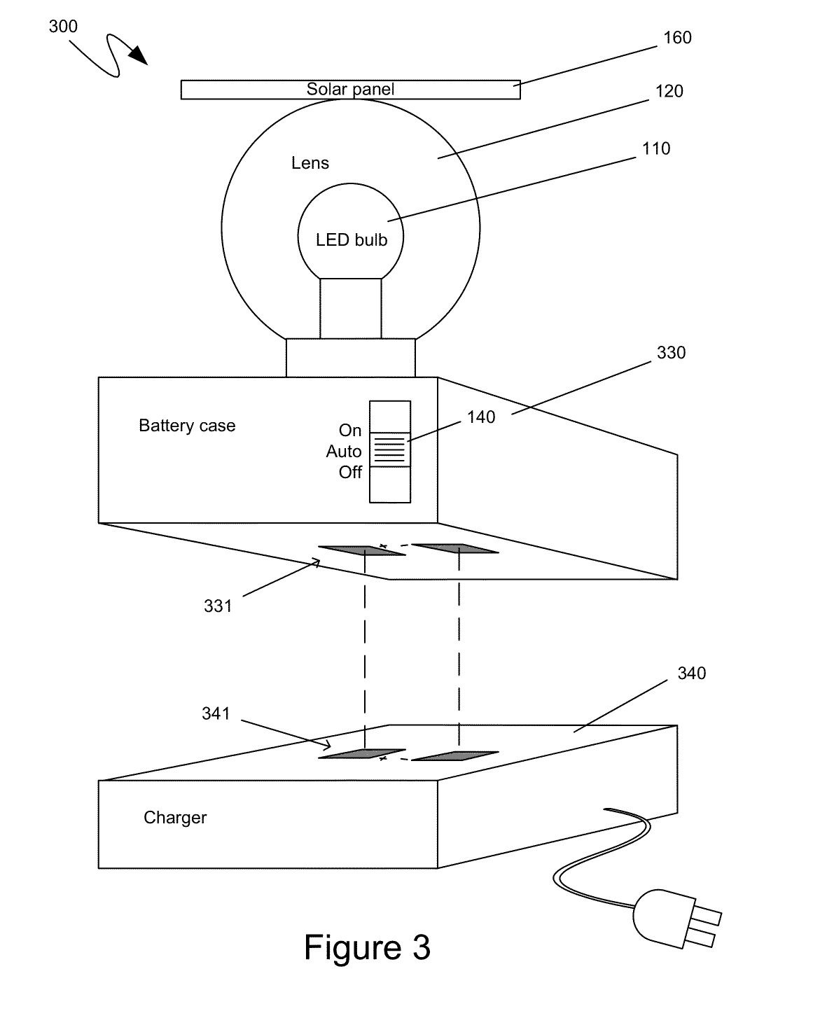

In one embodiment, complementary to the ability of the light-based alert device to be easily and efficiently attached and detached from a vehicle or other like supporting structure, the light-based alert device can comprise docking capability by which the light-based alert device can remain docked until needed and, thereby, recharge the battery or other like energy storage mechanism. Turning to FIG. 3, the exemplary light-based alert system 300 shown therein illustrates an exemplary light-based alert device, having analogous components to those described in detail above, except that the battery case 330 can comprise docking connectors 331 by which the battery case 330 can be docked onto a dock, such as the exemplary charger 340. When docked, the docking connectors 331 of the exemplary battery case 330 can align with corresponding docking connectors 341 of the exemplary charger 340. Through such an alignment, for example, electrical energy can flow from the charger 340 into the battery, or other like energy storage mechanism, contained in the battery case 330. When required for utilization, the exemplary light-based alert device can be efficiently undocked, such as by lifting the exemplary light-based alert device from the charger 340, and can be transported, and subsequently attached, to the vehicle, or other like supporting structure, within which context the exemplary light-based alert device will be utilized. Although the exemplary light-based alert system 300 of FIG. 3 illustrates a direct electrical connection, such as between the docking connector 331 and 341, other docking mechanisms can be utilized to provide for the transfer of energy, such as electrical energy, from the charger 340 to the battery in the battery case 330. For example, inductive charging mechanisms can be utilized, thereby avoiding exposed docking connectors, such as the exemplary docking connector 331 and 341.

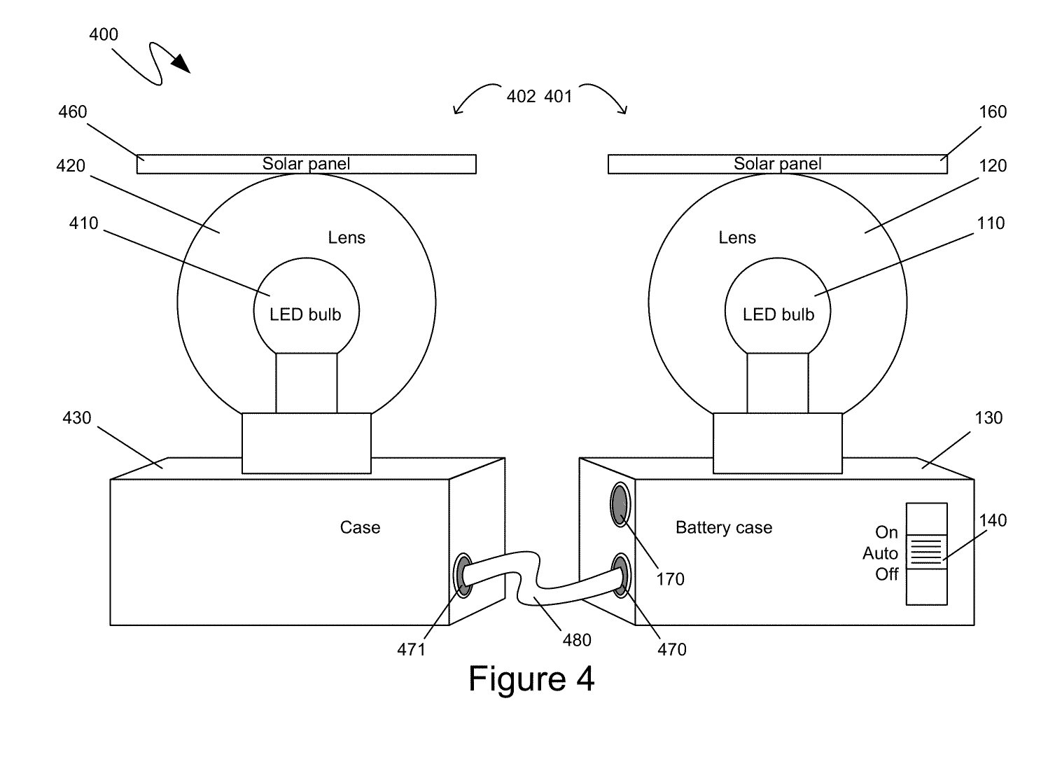

Turning to FIG. 4, an exemplary light-based alert system 400, comprising multiple light-based alert devices, such as the exemplary light-based alert devices 401 and 402, is illustrated therein. In one embodiment, as illustrated by FIG. 4, a secondary light-based alert device, such as the exemplary light-based alert device 402, can be efficiently added to a primary light-based alert device, such as exemplary light-based alert device 401, thereby taking advantage of at least some of the componentry and capabilities of the primary light-based alert device 401. More specifically, and for purposes of illustration, the exemplary light-based alert device 401 can comprise analogous components to those described in detail above. In addition, the exemplary light-based alert device 401 can comprise a port 470 by which the primary light-based alert device 401 can have one or more secondary light-based alert devices, such as the exemplary light-based alert device 402, communicationally coupled to it.

A secondary light-based alert device, such as the exemplary light-based alert device 402, can comprise a light source, such as the LED bulb 410, that can be analogous to the light source of the primary light-based alert device 401. Similarly, the exemplary light-based alert device 402 can comprise a lens 420 to protect the light source, as well as a case 430 that can include attachment mechanisms by which attachment of the secondary light-based alert device 402, to a vehicle or other supporting structure, can be facilitated. In one embodiment, however, the case 430 can differ from the battery case 130 of the primary light-based alert device 401 in that the exemplary case 430 need not comprise either a battery or any control circuitry other than a port 471 by which a communicational connection can be established with the primary light-based alert device 401, such as is illustrated by the exemplary cable 480. In such an embodiment, the primary light-based alert device 401 can comprise the battery, or other like energy storage mechanism, as well as control circuitry, or other like control apparatus, that can activate and deactivate the light-based alert. Control of the secondary light-based alert device 402 can then be achieved via the cable 480. For example, the cable 480 can provide electrical power to the LED bulb 410 of the secondary light-based alert device 402. Furthermore, the cable 480 can be connected, such as within the battery case 130, such that electrical power only travels through the cable 480 when the control circuitry inside the battery case 130 activates the LED bulb 110.

In one embodiment, the secondary light-based alert device 402 can further comprise its own solar panel 460. In such an embodiment, the cable 480 can comprise additional wiring by which electrical energy, generated by the exemplary solar panel 460, can be provided to the battery, or other like energy storage mechanism, in the battery case 130. In such a manner, the effective area on which incident sunlight is captured and converted into electrical energy can be increased, such as by the exemplary solar panel 460. The solar panel 460, on secondary light-based alert devices, such as the exemplary light-based alert device 402, can increase the surface area of solar panels that can be exposed to sunlight or other light from which such solar panels can generate electrical energy, and can, thereby, accelerate charging of the battery in the battery case 130 of the primary light-based alert device 401. In an alternative embodiment, the secondary light-based alert device 402 can lack a solar panel, such as the exemplary solar panel 460, so as to reduce the cost and complexity of such a secondary light-based alert device.

Because secondary light-based alert devices, such as the exemplary secondary light-based alert device 402, can lack energy storage components, control components, and, indeed, even the switch 140, and can, instead, utilize the functionality of such components as provided by the primary light-based alert device, the secondary light-based alert devices can provide additional light-based alerts at a fraction of the cost of installing additional ones of the primary light-based alert device.

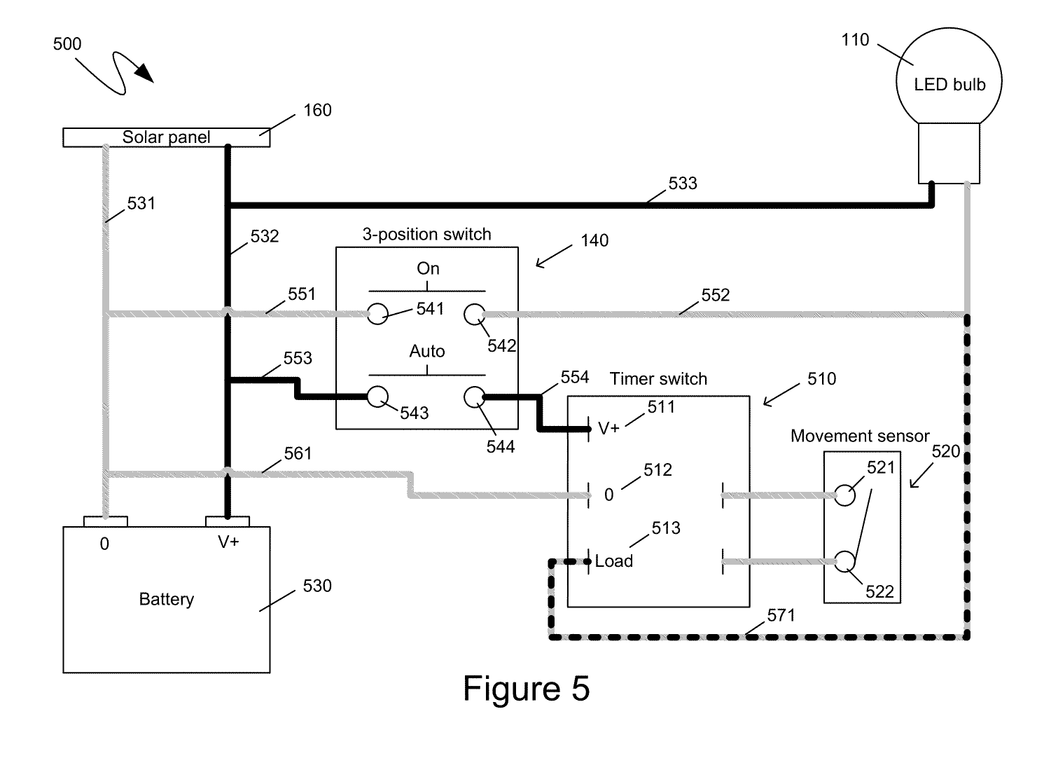

Turning to FIG. 5, an exemplary light-based alert device circuit 500 is shown therein. As illustrated by the exemplary light-based alert device circuit 500, a solar panel, such as the exemplary solar panel 160, or other like energy generation mechanism, can be communicatively coupled to a battery, such as exemplary battery 530, or other like energy storage device. For example, the wires 531 and 532 can electrically couple the solar panel 160 to the battery 530 such that, when the solar panel 160 is exposed to sunlight, electrical current flows from the solar panel 160 to the battery 530, via the wires 531 and 532, thereby charging the battery 530. Additionally, a light source, such as the exemplary LED bulb 110, can be connected to a power source, such as the exemplary battery 530. The connection, of the light source to the power source, can be through control circuitry that can control the activation and deactivation of the light source.

In one embodiment, activation and deactivation of the light source, such as the exemplary LED bulb 110, can be controlled by control circuitry comprising the three-position switch 140, described previously, in addition to a timer switch 510 and a movement sensor 520. More specifically, in such an embodiment, the exemplary three-position switch 140 can have an “On” position, an “Off” position and an “Auto” position. In the “Off” position, the exemplary three-position switch 140 can, electrically, be in the state illustrated in FIG. 5, where no electrical contact is made between the contact points 541 and 542, nor is there any electrical contact made between the contact points 543 and 544. In such an “Off” position, therefore, the exemplary LED bulb 110 can lack a completed circuit to a power source, such as the exemplary battery 530, and, consequently, can remain inactive. Conversely, in an “On” position, the exemplary three-position switch 140 can establish an electrical contact between the contact points 541 and 542, such that a circuit between the exemplary LED bulb 110, and a power source, such as exemplary battery 530, can be completed via the wires 532, 533, 552, 551 and 531. In such an “On” position, therefore, the exemplary LED bulb 110 can receive power from the power source, such as exemplary battery 530, and, consequently, can maintain an active state. Furthermore, the circuit by which the exemplary LED bulb 110 can receive electrical power from the exemplary battery 530 can be independent of the timer switch 510 and the movement sensor 520. Consequently, when the exemplary three-position switch 140 is in the “On” position, the operation of the LED bulb 110 can be independent of the timer switch 510 and the movement sensor 520.

When the exemplary three-position switch 140 is in the “Auto” position, the contact points 541 and 542 can remain disconnected and, instead, contact points 543 and 544 can become electrically connected. Consequently, in such an “Auto” position, the exemplary timer switch 510 can have an electrical connection to a power source, such as exemplary battery 530, via the wires 561, 553 and 554, which can be connected to the connections 512 and 511, respectively, on the exemplary timer switch 510. In one embodiment, when the timer switch 510 is electrically coupled to the battery 530, such as via the exemplary three-position switch 140 being in the “Auto” position, the timer switch 510 can be controlled by the movement sensor 520. More specifically, if the movement sensor 520 does not detect structural motion, it can remain in the position illustrated in FIG. 5, where there is no electrical connection between the points 521 and 522. The lack of an electrical connection between the points 521 and 522 can result in the timer switch 510 having an electrical connection between the connection 511 and 513. Consequently, the exemplary LED bulb 110 can have an incomplete electrical connection to the battery 530, as both terminals of the LED bulb 110 can be connected to a same terminal of the battery 530, such as via the wires 532, 533, 571, 554 and 553, respectively. As such, the exemplary LED bulb 110 can remain in an inactive state. Conversely, if, the movement sensor 520 does detect structural motion, a connection can be made between the points 521 and 522. Such a connection can cause the exemplary timer switch 510 to establish a connection between the connections 512 and 513, thereby establishing an electrical circuit between the exemplary LED bulb 110 and the battery 530, such as via the wires 532, 533, 571, 561 and 531, respectively. Consequently, the exemplary LED bulb 110 can be in an active state.

In one embodiment, when triggered by the movement sensor 520, such as by establishment of an electrical connection between the points 521 and 522, due to the movement sensor 520 sensing structural motion, the exemplary timer switch 510 can maintain the electrical connection between the connections 512 and 513 until a predefined period of time after the movement sensor 520 no longer senses structural motion and interrupts electrical connection between the points 521 and 522. As such, the timer switch 510 can introduce a delay between the ceasing of structural motion, as detected by the movement sensor 520, and the deactivation of the exemplary LED bulb 110. Such a predefined period of time, by which the exemplary timer switch 510 delays the deactivation of the exemplary LED bulb 110, can be anything from a few seconds to a few hours. In one preferred embodiment, such a predefined period of time can be 20 minutes. In another preferred embodiment, such a predefined period of time can be 10 minutes. In one embodiment, the predefined period of time by which the exemplary timer switch 510 delays the deactivation of the exemplary LED bulb 110 can be user-settable. For example, a user-accessible switch can enable the user to adjust the time period of such a delay. Such a user-accessible switch can, in one embodiment, operate a potentiometer, or other like adjustable device, which can be electrically or communicationally coupled to the timer switch 510 and can impact the time period by which the exemplary timer switch 510 delays deactivation of the exemplary LED bulb 110.

When mounted on a vehicle, therefore, the exemplary automated light-based alert device activates the light source, such as the exemplary LED bulb referenced above, when the vehicle starts moving, as detected by a movement sensor. Once the vehicle stops moving the light source can, optionally, remain in operation until a pre-defined delay time period elapses. If the vehicle recommences movement prior to the expiration of the pre-defined delay time period, then the light source remains in continuous operation. Conversely, if the vehicle remains stationary for longer than the pre-defined delay time period, then the mechanisms described in detail above act to cease operation of the light source to conserve the battery.

In such a manner, one or more of the exemplary automated light-based alert devices described in detail above can be conveniently attached to a vehicle, such as a trailer, farm equipment, a container, a bicycle, or any other kind of vehicle or portions thereof or cargo carried or transported thereby. The exemplary automated light-based alert devices can commence operation automatically, can act to conserve battery when appropriate, can self-recharge, such as through a solar panel or other like device, and can be easily and efficiently removed when their operation is no longer required.

Although the above-described mechanisms have been described within the context of wired connections, wireless connections can equally be utilized. For example, the exemplary three-position switch 140 can be controlled through wireless signals, such as wireless signals that could be generated by a mobile computing device or other like wireless signal transmitter. In such an embodiment, control of the exemplary three-position switch 140 can be affected without a user having physical access to the exemplary three-position switch 140. As another example, the exemplary movement sensor 520 can be a movement sensor that is part of a mobile computing device, such as the ubiquitous smart phone. In such an embodiment, the detection of motion can be performed by the mobile computing device, and the exemplary timer switch 510 can be communicationally coupled to such a mobile computing device by wireless signals. The mobile computing device can then wirelessly inform the timer switch 510 of the detection of motion, or the lack thereof. As yet another example, the delay aspect of the timer switch 510 can, likewise, be a function performed by the mobile computing device and the exemplary timer switch 510 can simply be a wirelessly controlled switch that alternatively activates or deactivates the exemplary LED bulb 110 in accordance with wireless control signals transmitted by such a mobile computing device. In such an embodiment, automated light-based alert devices may not comprise movement sensors or timers and can, instead, merely comprise one or more wirelessly controlled switches that can be wirelessly communicationally coupled to a mobile computing device that can be co-located with such automated light-based alert devices, such as by being carried on the person of a user operating a vehicle on which such automated light-based alert devices are mounted.

As can be seen from the above descriptions, an automated light-based alert device and system have been presented.

We claim:

1. An automated light alert device comprising:
a light source;
an energy storage device coupled to the light source, the light source emitting light when provided with energy from the energy storage device;
a switch controlling provision of the energy from the energy storage device to the light source; and
a movement sensor coupled to the switch, the switch comprising a first setting in which the switch allows for the energy from the energy storage device to be provided to the light source only if the movement sensor has detected movement of the automated light alert device.

2. The automated light alert device of claim 1, further comprising an energy generation device that generates energy from environmental aspects.

3. The automated light alert device of claim 2, wherein the energy generation device is a solar panel.

4. The automated light alert device of claim 1, further comprising a timer coupled to both the movement sensor and to the switch, the timer causing the switch, in the first setting, to continue to allow the energy from the energy storage device to be provided to the light source for a predefined period of time after the movement sensor stops detecting the movement of the automated light alert device.

5. The automated light alert device of claim 4, further comprising an adjustable device by which the predefined period of time can be changed.

6. The automated light alert device of claim 1, wherein the switch comprises a second setting in which the switch allows for the energy from the energy storage device to be provided to the light source irrespective of the movement sensor and a third setting in which the switch prevents the energy from the energy storage device to be provided to the light source irrespective of the movement sensor.

7. The automated light alert device of claim 1, further comprising a case;
wherein the light source is mounted on a first exterior side of the case and the energy storage device is located within the case.

8. The automated light alert device of claim 7, wherein the case comprises, on a second exterior side, at least one of a magnet, a strap or a bracket that attaches the automated light alert device to a vehicle.

9. The automated light alert device of claim 7, wherein the case comprises, on a second exterior side, a power plug coupled to the energy storage device, the energy storage device being rechargeable through the power plug.

10. The automated light alert device of claim 7, wherein the case comprises, on a second exterior side, one or more docking connectors coupled to the energy storage device and spaced apart to align with corresponding docking connectors on a dock connected to an energy source, the energy storage device being rechargeable through the docking connectors when the case is positioned on the dock such that the one or more docking connectors on the exterior side of the case are coupled to the corresponding docking connectors on the dock.

11. The automated light alert device of claim 1, further comprising a protective lens surrounding the light source.

12. The automated light alert device of claim 11, wherein at least one of the protective lens or the light source are colored such that the light emitted from the light source, after passing through the protective lens, is colored in accordance with applicable law or regulations relevant to the utilization of the automated light alert device.

13. The automated light alert device of claim 1, wherein the light source is an LED bulb and the energy storage device is a battery.

14. The automated light alert device of claim 1, wherein the movement sensor is coupled to the switch through a wireless communicational connection.

15. The automated light alert device of claim 14, wherein a smartphone comprises the movement sensor.

16. An automated light alert system comprising:
a first automated light alert device comprising a first light source;
a second automated light alert device comprising a second light source, the second automated light alert device being physically distinct and separate from the first automated light alert device;
a communicational coupling between the first and the second automated light alert devices;
a first energy storage device coupled to at least one of the first light source or the second light source;
a switch controlling provision of the energy from the energy storage device to the at least one of the first light source or the second light source; and
a movement sensor coupled to the switch, the switch comprising a first setting in which the switch allows for the energy from the energy storage device to be provided to the at least one of the first light source or the second light source only if the movement sensor has detected movement of the automated light alert system.

17. The automated light alert system of claim 16, wherein:
the communicational coupling comprises a cable connecting the first automated light alert device to the second automated light alert device;
one of the first automated light alert device or the second automated light alert device comprises the first energy storage device;
one of the first automated light alert device or the second automated light alert device comprises the switch; and
one of the first automated light alert device or the second automated light alert device comprises the movement sensor.

18. The automated light alert system of claim 16, further comprising a centralized controller physically distinct and separate from both the first and the second automated light alert devices, the centralized controller comprising the switch wherein the communicational coupling between the first and the second automated light alert devices comprises a communicational coupling between the centralized controller and at least one of the first automated light alert device or the second automated light alert device.

19. The automated light alert system of claim 16, further comprising one or more solar panels, at least one of which is coupled to the first energy storage device, the first automated light alert device comprising at least one of the one or more solar panels.

20. A method of equipping a vehicle with alert lights, the method comprising:
attaching, to the vehicle, at least one automated light alert device, the automated light alert device comprising:
a light source;
an energy storage device coupled to the light source, the light source emitting light when provided with energy from the energy storage device;
a switch controlling provision of the energy from the energy storage device to the light source; and
a movement sensor coupled to the switch, the switch comprising a first setting in which the switch allows for the energy from the energy storage device to be provided to the light source only if the movement sensor has detected movement of the automated light alert device; and
selecting the first setting on the switch.
